(19) United States
(12) Patent Application Publication
(10) Pub. No.: US 2024/0086920 A1
(43) Pub. Date: Mar. 14, 2024

(54) INTERMEDIARY-ENHANCED GRANULAR CONSENT MANAGEMENT

(71) Applicant: SYMCOR INC., Mississauga (CA)

(72) Inventors: Dmitriy KADUNOV, Calgary (CA); Rohit ROY, Oakville (CA)

(21) Appl. No.: 18/367,176

(22) Filed: Sep. 12, 2023

Related U.S. Application Data
(60) Provisional application No. 63/405,669, filed on Sep. 12, 2022.

(51) Int. Cl. G06Q 20/40; G06Q 20/10; G06Q 20/38

(52) U.S. Cl. CPC G06Q 20/4014; G06Q 20/108; G06Q 20/3829

(57) ABSTRACT

By interposing a data access platform between a data receiver and a data provider, many tasks may be simplified, enhanced or enabled. For one example, granular consent management may be facilitated. Upon receiving, at the data access platform, a first request for user account details, the data access platform may determine that the first request includes a first token that has been issued to the data receiver by the data access platform. The data access platform may, responsively, transmit, to the data provider, a second request for user account details. In particular, the data access platform may include, in the second request, a second token that has been issued to the data access platform by the data provider. The token management by the data access platform may be shown to allow the data access platform to provide, to the data receiver, more granular user account details than are available from the data provider.

### CROSS-REFERENCE TO RELATED APPLICATIONS

The present application claims priority from U.S. provisional patent application No. 63/405,669, filed Sep. 12, 2022, the entire contents of which are incorporated herein by reference.

### TECHNICAL FIELD

The present disclosure relates, generally, to consent management and, in particular embodiments, to a granular consent management that is enhanced by an intermediary.

### BACKGROUND

Conventional consent management systems allow a data provider system to exert control over sharing privileges for controlled data. Conventional consent management systems may rely upon the data provider system, at which the data is resident, to implement an access control system to govern access, by a data recipient, and distribution of the data. However, changes to consent management systems at the data provider systems may be expensive and time-consuming to implement. Furthermore, changes, at the data provider systems, to the consent management systems may also be expensive and time-consuming for the data recipients. Indeed, the data recipients are expected to integrate separately with each data provider and the respective consent management system of each data provider. The costs to a single data recipient may be shown to increase dramatically with the number of data providers for which respective consent management system changes are to be handled.

### SUMMARY

Aspects of the present application relate to providing an intermediary layer between a data recipient and a data provider. The intermediary layer may be used to provide, to the data recipient, an appearance of a granular consent management for the data provider system when that data provider system lacks granular consent management. The intermediary layer may also be used to provide, to the data recipient, an appearance of a granular consent management for the data provider system when that data provider system has a consent management system that is incompatible or when that data provider system lacks certain desired capabilities.

It may be considered that achieving granular consent management at a data provider back end system that lacks granular consent management may involve implementing an overhaul of the data provider back end system.

By interposing a data access platform between a data receiver and a data provider, many tasks may be simplified, enhanced or enabled. By facilitating, in this way, granular consent management, an overhaul of data provider back end systems may be avoided. The data access platform may also be able to provide additional security mechanisms and features that may not be directly supported by the data provider (e.g., mutual Transport Layer Security, “mTLS” or certificate-bound tokens). The data access platform may be implemented in a manner that allows for a single data recipient to access multiple data providers. The data access platform may be shown to allow for a standardization of capabilities between the single data recipient and the multiple data providers. Conveniently, such a standardization of capabilities may be achieved without implementing an overhaul at any of the multiple data providers.

The data access platform may be configured to expose a certain Application Programming Interface (API) to either the data recipient or the data provider. It may be considered easier and more straightforward to update an API exposed by the data access platform than it would be to update an API exposed by the data provider. Again, an overhaul of data provider back end systems may be avoided. In a scenario wherein the data access platform allows a single data recipient to access multiple data providers, a change to a single API may be shown to be preferable over implementing the same change to the multiple APIs exposed by the multiple data providers.

According to an aspect of the present disclosure, there is provided a method of facilitating granular consent management. The method includes receiving, at a data access platform from a data receiver, a first request for user account details, the first request including a first token that has been issued to the data receiver by the data access platform. The method further includes transmitting, from the data access platform to a data provider, a second request for user account details, the second request including a second token that has been issued to the data access platform by the data provider.

According to an aspect of the present disclosure, there is provided a method of enabling granular consent management between one or more open banking data recipients and one or more open banking data providers. The method includes registering, by a data access platform, one or more open banking data recipients and one or more open banking data providers and receiving, from a first open banking data recipient among the one or more open banking data recipients, a request for access to open banking data for a given user at a first open banking data provider among the one or more open banking data providers. The method further includes confirming, at the data access platform, an identity for the given user to, thereby, ensure that the given user is entitled to access the open banking data for the given user at the first open banking data provider and the open banking data recipient is entitled to access the open banking data for the given user at the first open banking data provider. The method also includes obtaining, by the data access platform, a first set of granular consents from the first open banking data provider, where the first set of granular consents are supported by existing data feeds of the first open banking data provider and expanding, by the data access platform, the first set of granular consents to a second set of granular consents that are not supported by the existing data feeds of the first open banking data provider, thereby enabling the open banking data recipient to present, to the given user, the second set of granular consents.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a block diagram, a known arrangement wherein a data recipient exchanges communication with a data provider;

FIG. 2 illustrates, in a block diagram, an arrangement wherein a data access platform interposes the data recipient and the data provider of FIG. 1, according to aspects of the present application;

FIG. 3 illustrates, in a block diagram, that the data access platform may include a dynamic client registration module, according to aspects of the present application;

FIG. 4 illustrates, in a block diagram, that the data access platform may include an authentication and consent management module, which, in turn, may include an identity provider discovery module, a scope change module, a data transformation module and a security module, according to aspects of the present application;

FIG. 5 illustrates, in a block diagram, that the authentication and consent management module may include a consent page module, according to aspects of the present application;

FIG. 6 illustrates, in a block diagram, that the data access platform may include a financial data exchange module, according to aspects of the present application;

FIG. 7 illustrates, in a block diagram, that the data access platform may facilitate interaction between the single data recipient and a plurality of data providers

FIG. 8 illustrates, in a block diagram, that the data access platform may facilitate interaction between a plurality of data recipients and a plurality of data providers; and

FIG. 9 illustrates, in a block diagram, that the data access platform may facilitate interaction between a plurality of data recipients and a single data provider.

### DETAILED DESCRIPTION

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

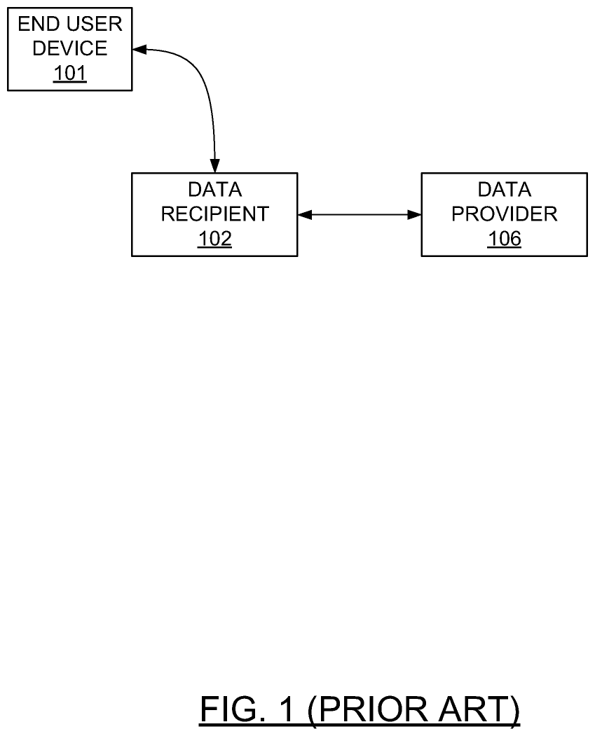

Referring to FIG. 1, which is representative of a known arrangement, an end user device 101 is illustrated exchanging communication with a data recipient 102. The data recipient 102 is illustrated exchanging communication with a data provider 106. In more specific aspects of the arrangement illustrated in FIG. 1, the data provider 106 is a financial institution, such as a bank. In such a case, the end user device 101 may be associated with a customer of the bank. The end user device 101 may be implemented as, for but a few examples, a smart phone, a tablet computer, a notebook computer, etc. Generally, the end user device 101 may execute a banking application, which may be characterized as a Financial Technology (“FinTech”) application. One example of such an FinTech application is the known Mint application, by Intuit of Mountain View, California. Accordingly, the data recipient 102 may be a server associated with the FinTech application.

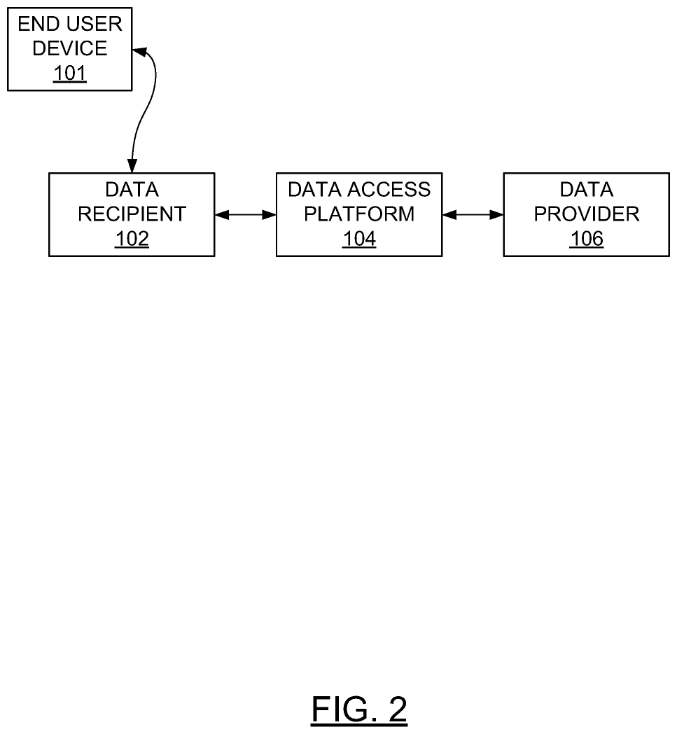

Aspects of the present application relate to actions carried out by a data access platform 104 that may be arranged, as illustrated in FIG. 2, to interpose the data recipient 102 and the data provider 106.

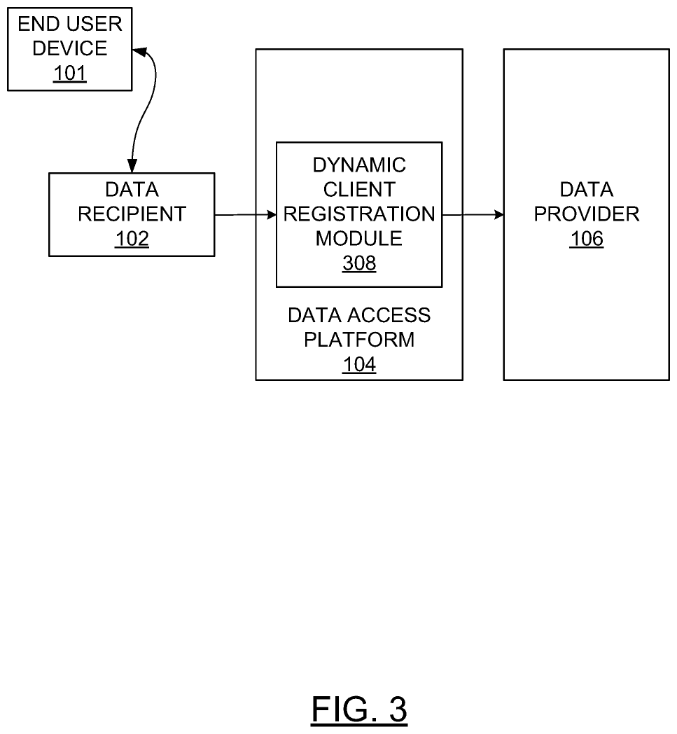

As illustrated in FIG. 3, the data access platform 104 may include a dynamic client registration module 308.

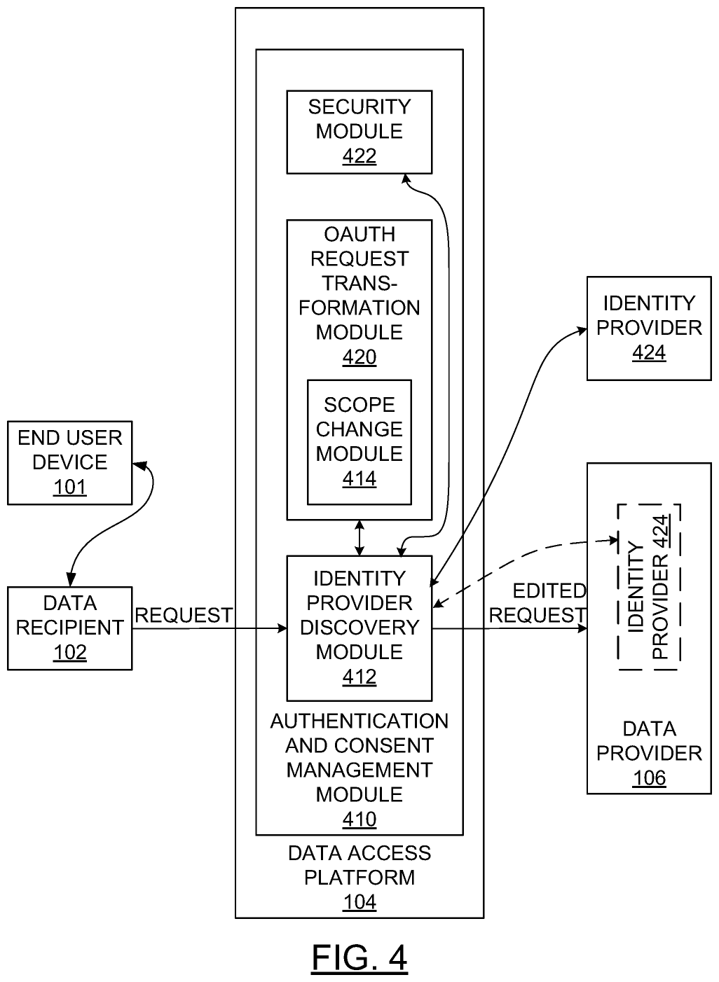

As illustrated in FIG. 4, the data access platform 104 may include an authentication and consent management module 410. The authentication and consent management module 410 may include multiple submodules, including an identity provider discovery module 412, a scope change module 414, as part of an oAuth request transformation module 420, and a security module 422. As illustrated in FIG. 4, the data provider 106 may be associated with an identity provider 424. The identity provider 424 may be separate from the data provider 106 or incorporated within the data provider 106.

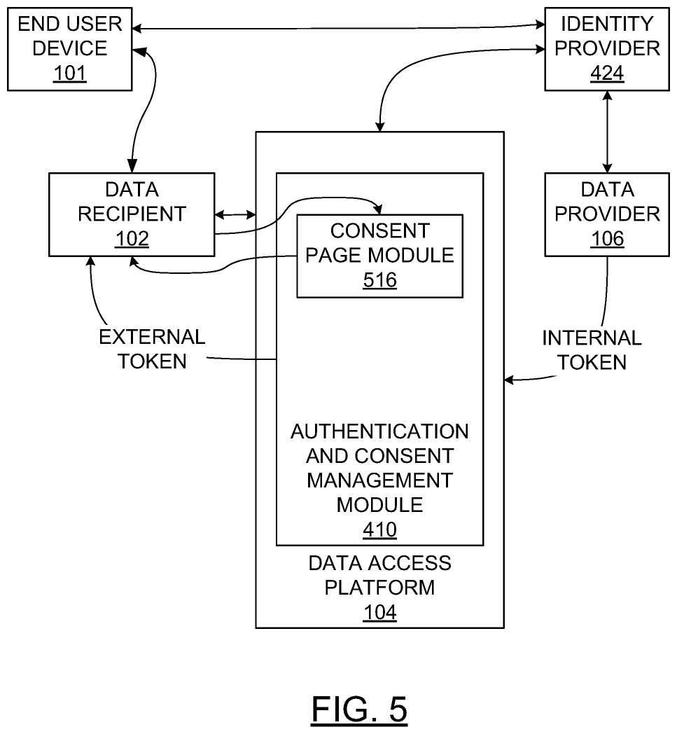

As illustrated in FIG. 5, the authentication and consent management module 410 may also include a consent page module 516.

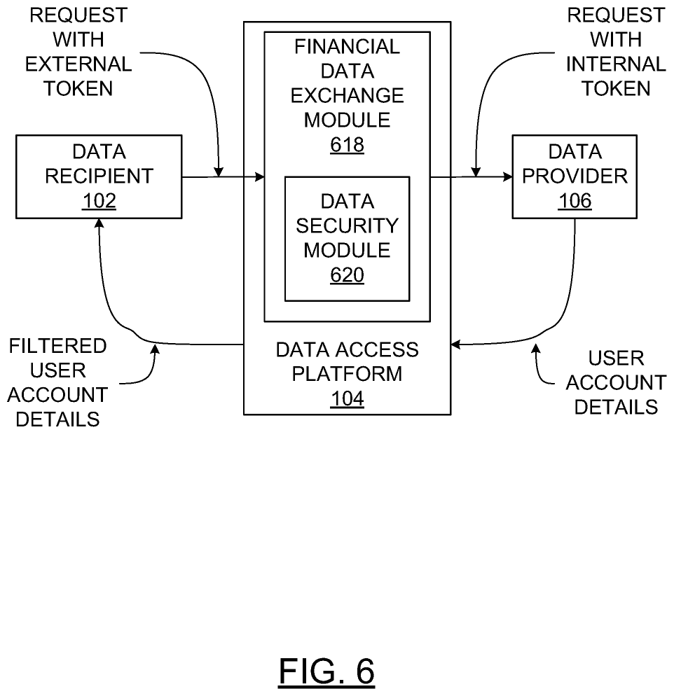

As illustrated in FIG. 6, the data access platform 104 may include a financial data exchange module 618, which may include a data security module 620.

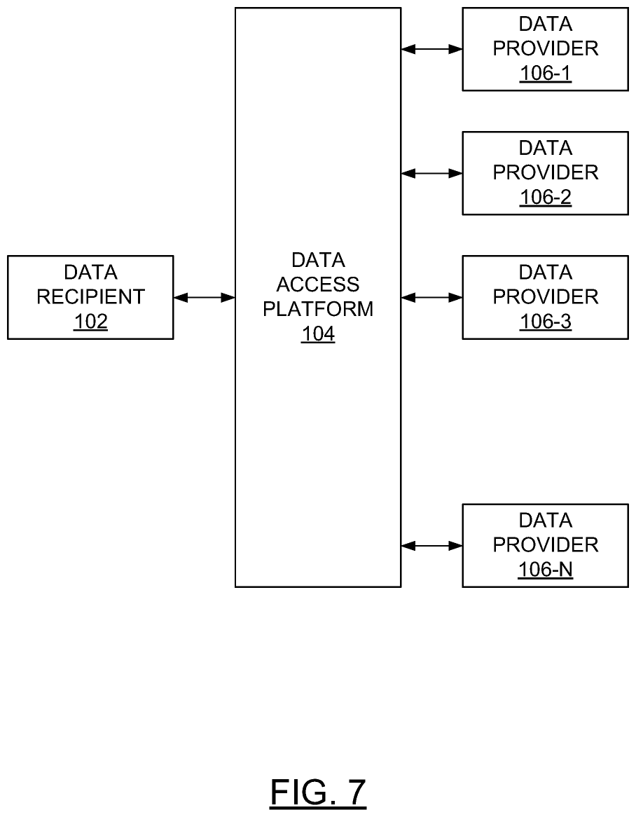

Aspects of the present application may be shown, as illustrated in FIG. 7, to allow the data access platform 104 to facilitate interaction between the single data recipient 102 and a plurality of data providers 106-1, 106-2, 106-3, . . . , 106-N.

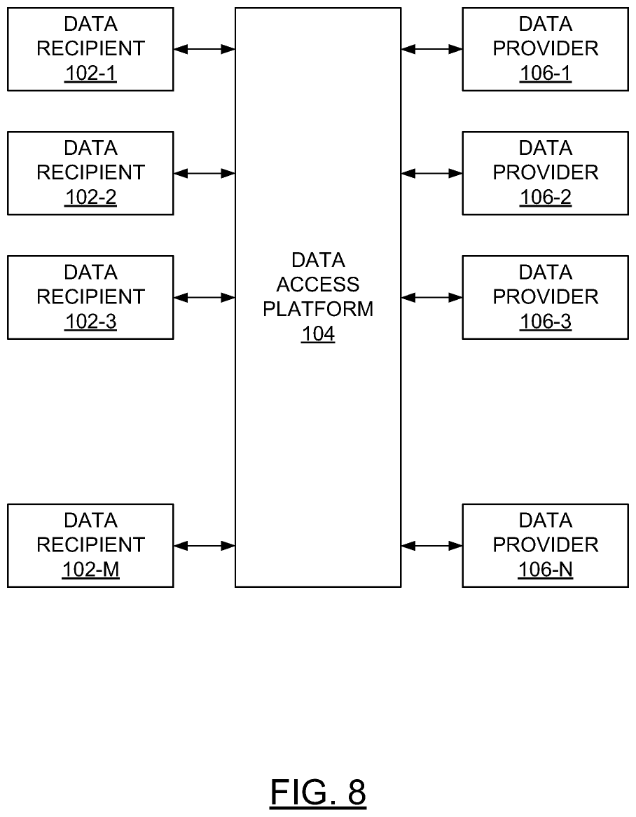

Aspects of the present application may be shown, as illustrated in FIG. 8, to allow the data access platform 104 to facilitate interaction between a plurality of data recipients 102-1, 102-2, 102-3, . . . , 102-M, and the plurality of data providers 106-1, 106-2, 106-3, . . . , 106-N.

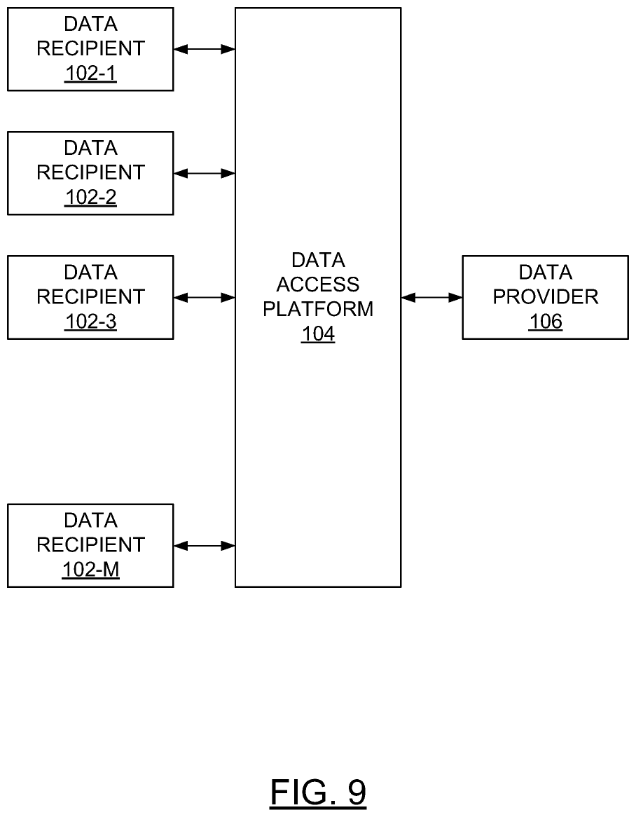

Aspects of the present application may be shown, as illustrated in FIG. 9, to allow the data access platform 104 to facilitate interaction between the plurality of data recipients 102-1, 102-2, 102-3, . . . , 102-M, and the data provider 106.

In operation in view of FIG. 3, the data recipient 102, under control of the FinTech application executed at the end user device 101, may transmit a message to the data access platform 104 to, thereby, register the FinTech application with the data access platform 104. The dynamic client registration module 308, at the data access platform 104, may receive the message and, responsively, the dynamic client registration module 308 may communicate with the data provider 106 to register the data recipient 102. The dynamic client registration module 308 may allow the data access platform 104 to implement data recipient application management. For example, a logo of the FinTech application at the end user device 101 may change. In such a case, the data recipient 102 may inform the dynamic client registration module 308 at the data access platform 104 of the change. Responsively, the data access platform level 104 may propagate the change to the data provider 106 or to the plurality of data providers 106-1, 106-2, 106-3, . . . , 106-N.

In general, to ensure authenticated and secure access between the data recipient 102 and one or more data providers 106, the data recipient 102 experiences an onboarding process, via interaction with the data access platform 104. The onboarding process involves registering the data recipient 102 (in particular, the FinTech application executed at the end user device 101) with an identity provider 424 associated with the data provider 106. A dynamic client registration protocol may be defined for this purpose. Conveniently, the data access platform 104 may be configured to handle differences between a manner in which each data provider 106, among a plurality of data providers 106, acts to register each data recipient 102 among a plurality of data recipients 102. Accordingly, each data recipient 102 among a plurality of data recipients 102 may register, more easily and with more consistency, with the plurality of data providers 106. Indeed, the combination of the data access platform 104 and the data recipient 102 may allow the end user device 101 to present, to the user, a user interface with a relatively consistent layout. The relatively consistent layout may, in some cases, differ little more than in an indication, say, a logo, of a brand for the data provider 106.

The data provider 106 may create a client for the data access platform 104. The client may be specific to the onboarding process for the FinTech application. The client created by the data provider 106 may be received at, and stored at, the data access platform 104. Notably, the client is not propagated to the data recipient 102. A “virtual” client registration is created at the data access platform 104. This “virtual” client is communicated to the data recipient 102. The data access platform 104 maintains mappings between each singular “virtual” client and the many clients that have been received from, and are specific to, particular data providers 106.

Subsequently, in view of FIG. 4, the FinTech application at the end user device 101 may cause the data recipient 102 to transmit a request to the data access platform 104. The request may indicate a scope. For example, the request may indicate that the scope is “FinTech Allowed Scope.” For another example, the request may indicate that the scope is “ACCOUNT_DETAILS TRANSACTIONS.” In this latter example, the FinTech application is asking for permission to be able to see a particular user's detailed account information and transactional history.

Upon receipt of the request, the data access platform 104 may act to verify the request from a security point of view and from an access point of view. The data access platform 104 may act to verify whether the FinTech application is allowed to make a request with the indicated scope. The data access platform 104 may, subsequently, determine the specific data provider 106, among a plurality of data providers (see FIG. 7), for which the request is intended. The oAuth request transformation module 420 of the data access platform 104 may then, if necessary, transform the scope of the request to a scope that that may be readily understood by the specific data provider 106. For example, the oAuth request transformation module 420 may transform the scope of the request from “ACCOUNT_DETAILS TRANSACTIONS” to “FinancialInformation”). The oAuth request transformation module 420 may then, if necessary, transform the type of the request to a type that that is known to be supported by the specific data provider 106. For example, the oAuth request transformation module 420 may transform the type of the request from “mTLS” to “authorization code flow with secret.” This transformation may occur responsive to the data access platform 104 determining that the “mTLS” request type is not supported by the specific data provider 106.

The oAuth request transformation module 420 may then edit the request to create an edited request that includes, appended thereto, security information about the data access platform 104 and the data recipient 102. The data access platform 104 may then transmit the edited request to the specific data provider 106. The oAuth request transformation module 420 may then edit the request to convert a first mechanism in the request to a second mechanism for the edited request, where the second mechanism is known to be understood by the data provider 106.

Upon receipt of the edit request, the specific data provider 106 may be able to determine that the edited request came from the data recipient 102 through the data access platform 104. Upon receipt of the edit request, the specific data provider 106 may be able to determine that the specific data provider 106 understands the edited request and can act to process to the edited request. Once the specific data provider 106 has processed the edited request to obtain information, the specific data provider 106 may transmit the obtained information to the data access platform 104.

At the authentication and consent management module 410 of the data access platform 104, upon receipt of the request, the identity provider discovery module 412 may determine the identity provider 424 to associate with the request. Upon determining the identity provider, the identity provider discovery module 412 may communicate with the identity provider. Conveniently, the identity provider discovery module 412 may be provided with an ability to register and manage the data recipient 102 within an identity platform associated with the data provider 106 and handled by the identity provider. In particular, the identity provider discovery module 412 may communicate with the identity provider through use of dynamic client registration (DCR) calls. Registering, updating and deleting client information may be accomplished as the identity provider discovery module 412 communicates with the identity provider. Further particularly, the identity provider discovery module 412 may transform DCR calls, received from the data recipient 102, to specifically understands by the identity provider 424. The identity provider discovery module 412 may be provided with an ability to securely redirect, to the identity provider 424, user traffic that is related to an authentication process for authenticating the user of the end user device 101 to obtain data from the data provider 106. The user traffic may include a username, a password and elements of multi-factor authentication. The identity provider discovery module 412 may also be provided with an ability to receive, from the identity provider 424, information about the results of the authentication process. “Scope transformation” may occur at this level. “Authorization call transformation” may also occur at this level. The identity provider discovery module 412 may further be provided with an ability to revoke and/or manage internal tokens, to be discussed hereinafter.

The identity provider discovery module 412 may also pass the request to the scope change module 414. The scope change module 414 may alter the request to form an altered request. The editing may change the scope of the request from “FinTech Allowed Scope” to “Bank Scope” and return the altered request to the identity provider discovery module 412. The scope change module 414 may operate in accordance with up-to-date OAuth standards. In an example case, the scope change module 414 may be referenced as an OAuth2.0 scope change module 414. For the OAuth standards, see RFC 7591—OAuth 2.0 Dynamic Client Registration Protocol at datatracker.ietf.org/doc/rfc7591/.

The identity provider discovery module 412 may then transmit the altered request to the data provider 106.

Subsequently, in view of FIG. 5, the FinTech application at the end user device 101 may cause the data recipient 102 to communicate with the data access platform 104 with an intent to be authenticated with the data provider 106. Based on information received from the data provider 106, the data access platform 104 may redirect the authentication-related communication to occur directly between the end user device 101 and the identity provider 106, as discussed hereinbefore.

Upon receiving, from the identity provider 424, an indication that the user has been authenticated, the data provider 106 may issue, to the data access platform 104, an “internal” token. It is understood that the internal token may only be used by the data access platform 104. Despite only being used by the data access platform 104, the internal token may be seen to relate to a specific combination of the data recipient 102 and the user of the end user device 101.

After completing authentication through communicating with the identity provider 424, the user may use the FinTech application at the end user device 101 to, via the data recipient 102, interact with the consent page module 516 as part of the authentication and consent management module 410. Through the interaction, the user may be presented with indications of user account details to which the user has access. The user may be presented, via the FinTech application executed on the end user device 101, with an indication of who is asking for data (e.g., a legal name of the data recipient 102), a description of the data to which the data recipient 102 is requesting access, an indication of other systems that are involved in sharing the data, for example, the data access platform 104, an indication of terms and agreements associated with the data access and a duration of time that the data access will be allowed. Responsively, the user may: review the information; cancel the request, thereby not providing consent; modify the request to alter the scope of the data for which access is requested; modify the request to alter the specific accounts of the data for which access is requested; modify the request to reduce the duration of time that the data access will be allowed.

In the context of the accessible user account details, the authentication and consent management module 410 may issue an “external” token to the data recipient 102.

In view of FIG. 6, the FinTech application at the end user device 101 may cause the data recipient 102 to transmit, to the data access platform 104, a request, for example, for user account details. It is known that a module is a software component and that an Application Programming Interface (API) may be considered to include instructions and, possibly, some tools, for using and communicating with a software component. It is expected that the FinTech application at the end user device 101 and the financial data exchange module 618 at the data access platform 104 are enabled to communicate using known financial data exchange (FDX) APIs. The request may include the external token that was issued, by the authentication and consent management module 410, to the data recipient 102.

Responsive to receiving the request, the financial data exchange module 618 may edit the request for transmission to the data provider 106. That is, the financial data exchange module 618 may include, in the edited request, the internal token that was issued, to the data access platform 104, by the data provider 106.

Notably, the data access platform 104 may have access to a large set of user account details from the data provider 106, where the large set extends beyond a smaller set of user account details to which the user has access. Accordingly, the data access platform 104 may be seen to act as a filter, or granular consent manager, of user account details. Accordingly, responsive to receiving the request, the data provider 106 may provide, to the data access platform 104, the requested data, for example, a set of user account details. The data access platform 104 may then provide, to the data recipient 102, those user account details to which the user has access. In a first example, the consent granted to the data recipient 102 allows the data recipient 102 to receive a user account balance but does not allow the data recipient 102 to receive transaction information for the same user account. Overall, the data provider 106 may provide data a first level of consent granularity. Through parsing actions carried out at the data access platform 104, the user of the end user device 101 may be able to customize the FinTech application to use a second level of consent granularity, where the second level of consent granularity is finer than the first level of consent granularity. For a second example, the consent granularity with respect to transaction data available from the data provider 106 may be binary, in that either data on all transactions is made available or data on no transactions is made available. Use of the data access platform 104 may enable provision of many distinct levels of data on transactions. The data access platform 104 may be configured to provide, to the data recipient 102, data only for debits for a first account and data only for credits for a second account. Notably, through actions controlled by the data security module 620, communications between the data provider 106 and the data recipient 102, through the data access platform 104, may be encrypted with a public key associated with the data recipient 102.

It is recognized that information that is specific to the user, the end user device 101 and/or the data recipient 102 may change over time. For one example, a status of the data recipient 102 may change. For another example, a level of access granted to the data recipient 102 may change. For a further example, commitment to participation in the environment that includes the data access platform 104 may change. For an even further example, brand or company information associated with the data recipient 102 may change. Notably, the data access platform 104 may be provided with a capability to temporarily disable a data recipient 102 due to operational concerns (e.g., a suspicion that the data recipient 102 has been hacked, information indicating that the data recipient is involved in an ongoing dispute, etc.). To manage those changes over time and to ensure that the identity provider 424 associated with the data provider 106 stays updated, the data access platform 104 may be configured to call appropriate endpoints associated with the data provider 106. The data provider 106 may be configured to expose, to the data access platform 104, specific APIs that support the initial registration of an application. Additionally, the data provider 106 may be configured to expose, to the data access platform 104, specific APIs that support a process to change the information associated with the data recipient 102.

The specific APIs that support a process to change the information associated with the data recipient 102 may be designed to follow OAuth and FDX standards. For the FDX standards, see RFC 0206—Recipient Registration With Delegation to an Ecosystem Registry.

The data access platform 104 may be configured to help with alternative forms of integration. For example, in a case wherein a particular data provider 106 does not support Dynamic Client Registration, the particular data provider 106 may allow for manual onboarding the data access platform 104. The data access platform 104 may then use a consistent client ID to interact with the particular data provider 106 on behalf of the data recipient 102. In order for data providers 106 to access information associated with data recipients 102, the data access platform 104 may expose an API that allows a data provider 106 to retrieve data recipient information.

Throughout the foregoing, the various tokens have been distinguished as an “external token” and an “internal token.” It should be clear that these tokens may be, more generically referenced as a first token and a second token.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A method of facilitating granular consent management, the method comprising:
receiving, at a data access platform from a data receiver, a first request for user account details, the first request including a first token that has been issued to the data receiver by the data access platform; and
transmitting, from the data access platform to a data provider, a second request for user account details, the second request including a second token that has been issued to the data access platform by the data provider.

2. The method of claim 1, further comprising:
receiving, from the data recipient, a message requesting registration with the data provider; and
communicating with the data provider to register the data recipient.

3. The method of claim 2, further comprising:
determining an identity provider to associate with the first request, wherein the identity provider is associated with the data provider for which the first request is meant; and
registering the data recipient with the identity provider.

4. The method of claim 1, further comprising:
receiving, from the data recipient, a request;
editing the message to form an edited request with changed scope; and
transmitting, to the data provider, the edited request.

5. The method of claim 4, further comprising:
determining an identity provider to associate with the request; and
including, in the altered request, an indication of the identity provider.

6. The method of claim 1, further comprising receiving, from the data provider, the second token.

7. The method of claim 1, further comprising:
receiving, from the data recipient, indications of consent regarding account details; and
issuing, to the data recipient, the first token.

8. The method of claim 7, further comprising encrypting the first token.

9. The method of claim 8, wherein the encrypting comprises using a public key associated with the data recipient.

10. The method of claim 1, further comprising:
receiving, from the data provider, user account details responsive to the second request; and
transmitting, to the data recipient, a subset of the user account details as a response to the first request.

11. The method of claim 10, further comprising encrypting the subset of the user account details.

12. The method of claim 11, wherein the encrypting comprises using a public key associated with the data recipient.

13. The method of claim 1, further comprising verifying the first request; and

14. The method of claim 1, further comprising converting a first mechanism for the first request to a second mechanism for the second request, where the second mechanism is known to be understood by the data provider.

15. A method of enabling granular consent management between one or more open banking data recipients and one or more open banking data providers, the method comprising:
registering, by a data access platform, one or more open banking data recipients and one or more open banking data providers;
receiving, from a first open banking data recipient among the one or more open banking data recipients, a request for access to open banking data for a given user at a first open banking data provider among the one or more open banking data providers;
confirming, at the data access platform, an identity for the given user to, thereby, ensure that:
the given user is entitled to access the open banking data for the given user at the first open banking data provider; and
the open banking data recipient is entitled to access the open banking data for the given user at the first open banking data provider;
obtaining, by the data access platform, a first set of granular consents from the first open banking data provider, where the first set of granular consents are supported by existing data feeds of the first open banking data provider; and
expanding, by the data access platform, the first set of granular consents to a second set of granular consents that are not supported by the existing data feeds of the first open banking data provider, thereby enabling the open banking data recipient to present, to the given user, the second set of granular consents.
